(19) United States
(12) Patent Application Publication
(10) Pub. No.: US 2015/0052095 A1
(43) Pub. Date: Feb. 19, 2015

(54) MODEL-BASED APPROACH TO INTELLIGENT AUTOMATION IN A COMPUTING DOMAIN

(71) Applicant: CISCO TECHNOLOGY, INC., San Jose, CA (US)

(72) Inventors: Kevin A. Yang, Fremont, CA (US); Vivek Vishnoi, Cupertino, CA (US)

(73) Assignee: CISCO TECHNOLOGY, INC., San Jose, CA (US)

(21) Appl. No.: 13/968,183

(22) Filed: Aug. 15, 2013

(51) Int. Cl. G06N 5/02

(52) U.S. Cl. CPC G06N 5/02
USPC 706/47

(57) ABSTRACT

A method is provided in an example and includes adding two or more objects to a model, receiving a request to establish a relationship between first and second objects of the two or more objects; and determining whether the relationship violates a design policy. The method also includes taking an action based on whether the relationship violates the design policy. More specific embodiments of the method include selecting a process from a set of processes for execution in a determined order, where successful execution of the set of processes in the determined order provisions the two or more objects to establish a model instance in a target. The more specific embodiments may further include determining whether the selected process violates a deployment policy, and taking an action based on whether the selected process violates the deployment policy.

### TECHNICAL FIELD

This disclosure relates in general to the field of computer systems and services and, more particularly, to providing a model-based approach to intelligent automation in a computing domain.

### BACKGROUND

As computer systems and services have grown increasingly complex, the demand for compute, storage, network, and processing capabilities have increased. Network infrastructures for an enterprise, for example, often contain a multitude of network elements including any suitable combination of hosts, servers, routers, switches, loadbalancers, security appliances, etc. Many different computing domains (also referred to herein as ‘domain’ and ‘domains’ for singular and plural references, respectively) have emerged to accommodate the growing demands related to complex computer systems and services of enterprises, service providers, and other entities. Generally, a computing domain is a group of one or more related computer systems that can be accessed and administered using the same protocols or rules. A data center configured in a virtualized cloud environment is one domain often used by service providers to host multiple enterprises and to provide desired resources to those enterprises. A private network infrastructure in which hardware and services are controlled and used by a particular enterprise is another example of a domain. Moreover, a domain could comprise any number of resources, including a single resource such as a server. Other domains may have hundreds, thousands, or even more resources.

Intelligent automation techniques often use process-driven approaches to define hierarchical workflow processes or activities, to accomplish a desired goal of an entity in a particular domain. As the complexity of a desired goal increases, and use cases explode, process bloat can occur and significantly complicate the management of the processes. Thus, enterprises, service providers, and other entities need better approaches for configuring and managing solutions for desired goals.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram illustrating a high level architecture of a system providing a model-based approach to intelligent automation in a computing domain in accordance with at least one embodiment of the present disclosure;

FIG. 2 is a simplified block diagram of possible example details associated with at least one embodiment of the intelligent automation system;

FIG. 3 is another simplified block diagram illustrating components associated with expressing desired states according to at least one embodiment;

FIG. 4 is a simplified diagram of a screen shot associated with an example dashboard of the intelligent automation system according to at least one embodiment;

FIG. 5 is a simplified flowchart illustrating potential operations associated with creating a service element according to at least one embodiment;

FIG. 6 is a simplified diagram of a screen shot associated with example service elements according to at least one embodiment;

FIG. 7 is a simplified flowchart illustrating potential operations associated with creating a process according to at least one embodiment;

FIG. 8 is a simplified diagram of a screen shot associated with an example process according to at least one embodiment;

FIGS. 9A and 9B are simplified flowcharts illustrating potential operations associated with composing a model according to at least one embodiment;

FIG. 10 is a simplified diagram of a screen shot associated with an example model according to at least one embodiment;

FIG. 11 is a simplified flowchart illustrating potential operations associated with deploying a model to a target according to at least one embodiment;

FIG. 12 is a simplified flowchart illustrating potential operations associated with monitoring a model instance according to at least one embodiment; and

FIGS. 13A and 13B are simplified flowcharts illustrating potential operations associated with modifying a model according to at least one embodiment.

### DETAILED DESCRIPTION OF EXAMPLE EMBODIMENTS

### Overview

A method for a model-based approach to intelligent automation in a computing domain is provided in at least one embodiment. The method includes adding two or more objects to a model and receiving a request to establish a relationship between first and second objects of the two or more objects. The method also includes determining whether the relationship violates a design policy and taking an action based on whether the relationship violates the design policy.

In some specific embodiments, the objects include one or more sub-models. In some other specific embodiments, the objects include one or more service elements. In yet other specific embodiments, the objects include at least one sub-model and at least one service element. In further specific embodiments, the method includes establishing the requested relationship between the first and second objects if the requested relationship does not violate any design policy of the first or second objects. In some embodiments, the method includes selecting a process from a set of processes for execution in a determined order. Successful execution of the set of processes in the determined order provisions the two or more objects to establish a model instance in a target. This specific embodiment may further include determining whether the selected process violates a deployment policy and taking an action based on whether the selected process violates the deployment policy.

### Example Embodiments

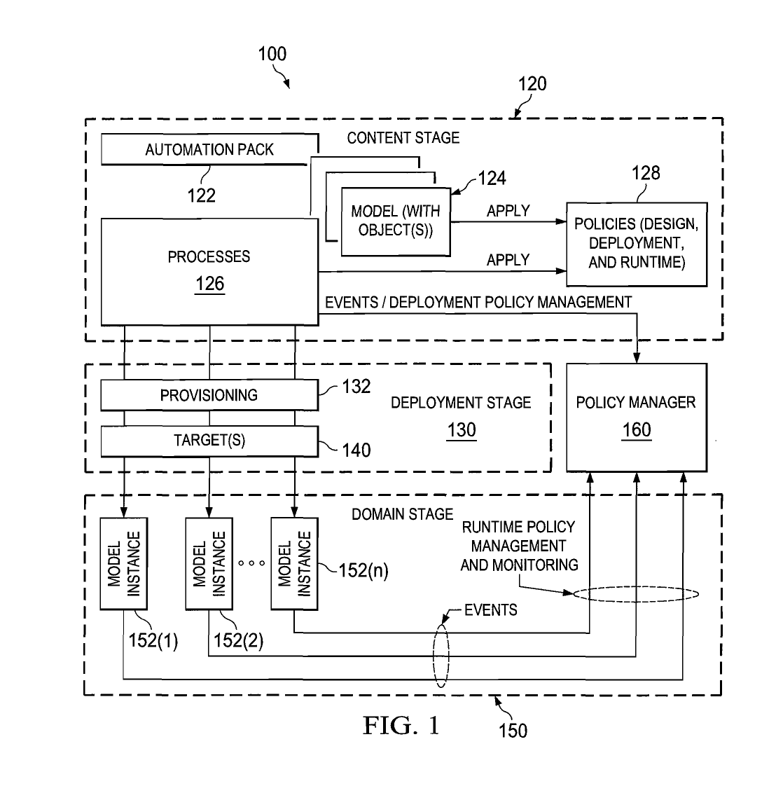

Turning to FIG. 1, FIG. 1 is a simplified block diagram illustrating a high level logical architecture of an intelligent automation system 100 that offers a model-based approach to intelligent automation in a computing domain. Generally, intelligent automation system 100 includes a content stage 120, a deployment stage 130, and a domain stage 150. An automation pack 122 in content stage 120 contains one or more models 124, processes 126, and policies 128. Models 124 comprise one or more objects (i.e., service elements and/or sub-models) and relationships can be created between the objects. One or more processes 126 may be applied at a service element level and/or at a model level. Policies 124 can include design policies, deployment policies, and runtime policies. These policies can be applied to models, service elements, and processes 126. During deployment stage 130, provisioning 132 of one or more models 124 to targets 140 can be performed. Domain stage 150 includes one or more model instances 152(1), 152(2), through 152(N) of provisioned models 124. Events that violate policies applied to models, service elements, or processes can be evaluated and managed by a policy manager 160. Policies could be violated during any stage, for example, when models are created in content stage 120, when models are being provisioned in deployment stage 130, or when models are running in targets 140 in domain stage 150.

According to embodiments in the present disclosure, intelligent automation system 100 can provide a model-based approach to intelligent automation in a particular domain. At least one embodiment disclosed herein can be applied in a multitude of domains (e.g., an enterprise, a private cloud, a service provider serving one or more tenants, etc.). The model-based approach can provide a clear separation of an end goal from actions taken to realize the goal. Embodiments of intelligent automation system 100 can enable the creation of declarative specifications to specify what to occur in data and to define a desired state of a service, or other solution, through a collection of related objects. As used herein, the term ‘object’ is intended to include a service element or a sub-model, and the term ‘objects’ is intended to include service elements, sub-models, or any suitable combination thereof, unless specifically indicated otherwise. Additionally, as used herein, a ‘sub-model’ is inclusive of at least one model used to compose a higher-level model, which may also be referred to as a ‘composite model’.

Models, including both composite models and non-composite models, can be defined by users and can drive the automation to achieve the end goal by decomposing the complex top level service into finer grained actions against the elemental level objects of the service. Through the composition of models (also referred to herein as ‘service models’), complex relationships can be specified either via top-down or bottom-up. In a bottom-up approach, a user can start from a lower-level to define objects such as service elements (e.g., Centos Linux Virtual Machine (VM), Apache Web server) and the relationships between them. The user can then define higher-level services, based on the service elements defined, to achieve the desired end goal. Alternatively, for a top-down approach, a user can define high-level services by composing reusable service components (e.g., service models, service elements, policies, processes, etc.). Nested service models allow automation to traverse the relationships via the prescribed execution order and realize the end goal based on the service composition and eventually build up the entire complex service model.

For purposes of illustrating example techniques of intelligent automation system 100, it is important to understand the communications that may be occurring in system 100. The following foundational information may be viewed as a basis from which the present disclosure may be properly explained.

Intelligent automation techniques often use process-driven approaches to define a set of complex hierarchical workflow processes or activities which invoke one another and pass data parameters to accomplish a desired goal of an enterprise or other entity. In this approach, intermediate steps of workflow activities are explicitly defined. For example, a process-driven approach could be used to define a solution in a cloud domain, such as creating a cloud infrastructure or virtual data center. In this scenario, workflow processes are typically defined by a user to create each of the desired elements of the virtual data center (e.g., a firewall, a webserver, a database, etc.), including the virtual data center itself. Covering all of the use cases for a particular solution can result in process bloat. Moreover, when the automation complexity increases, the process-driven approach may become difficult to develop and manage because there is no clear separation of implementation from the desired end states.

Some intelligent automation approaches are intended to leverage model-based approaches. Generally, however, these approaches are provided for particular domains. In addition, these approaches may rely on templates that are specific and static for the configuration. For example, some cloud services may be composed of a collection of elemental components that customers can order. Other model-based tools may provide flat level modeling in which a user may compose multiple tiers of components, such as a firewall tier, a web server tier, a compute tier, a database tier, etc. Policies may also be added to the components. Such tools, however, typically require users to define the physical layering needed to realize a desired tier. For example, if an application level component is defined, such as a virtual server, a user may need to define the physical infrastructure to support the application, such as a network address, firewall ports, etc.

Additionally, current model-based approaches generally use a one-time ‘fire and forget’ technique that detects a model and creates a model instance without further involvement with the deployed model. In many cases, however, model instances may need modifications after deployment, as the service being provided could be constantly (or at least periodically) changing in order to meet business needs, for example.

The intent or requirements for a particular goal related to computer systems and/or services, which is desired by an enterprise or other entity, are needed to appropriately configure and manage a solution in any domain. What is needed is a better way to capture the intent of an end goal of a solution being built and to avoid process bloat that may occur. More particularly, the ability to describe what an intelligent automation system does to achieve a goal, as opposed to defining how a particular solution is implemented, is desirable to manage and develop automation solutions as complexity increases. Additionally, effectively managing solutions during an entire life cycle (e.g., design, deployment, and instantiation) could provide significant advantages over current approaches.

In accordance with one example implementation, intelligent automation system 100 can resolve the aforementioned issues associated with intelligent automation. Intelligent automation system 100 provides a model-based approach that enables a user to express intent for a desired goal related to computer systems and/or services. The user is provided with the ability to define a declarative specification of automation, which means to describe what the automation does to achieve the goal and not how it is implemented (i.e., describing ‘what’ rather than ‘how’). The model-based approach of embodiments disclosed herein, alleviates problems with process-driven approaches, such as defining all possible use cases of a goal and experiencing process bloat. Instead, the model-based approach of system 100 provides a simplified iterative development process. A user can start by designing content required by a solution without needing to know how the solution is deployed in a target, which could be a physical or virtual data center. In particular, a user can create service elements, can design models and can define processes applied to service elements and/or models. Models can be designed by adding objects (i.e., service elements and/or sub-models) and defining relationships between the objects. Moreover, policies can be applied at the service element level, the process level, and/or the model level (including sub-models). Deployment elasticity allows a user to re-deploy the same solution to a different environment. A user can also modify the same solution and redeploy it for requirement and/or versioning evolution. Thus, the model-based approach extends the automation capability from one-time ‘fire and forget’ into full life cycle management.

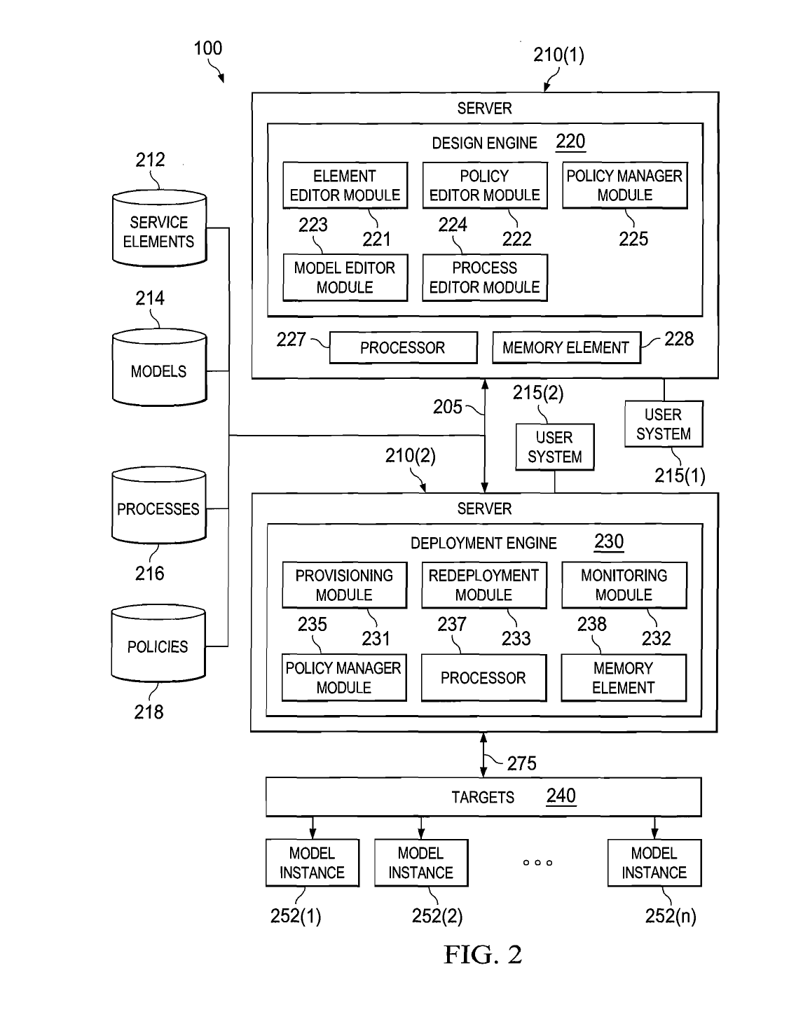

Turning to FIG. 2, FIG. 2 is a simplified block diagram illustrating a possible set of details associated with intelligent automation system 100. Servers 210(1) and 210(2) may communicate via a network 205. Server 210(1) hosts a design engine 220, and server 210(2) hosts a deployment engine 230. Deployment engine 230 of server 210(2) communicates with targets 240 via a network 275. User systems 215(1) and 215(2) may enable communication between users and servers 210(1) and 210(2), respectively. In at least one embodiment, various content (or data) is accessible to design engine 220, including data from service elements database 212, models database 214, processes database 216, and policies database 218. At least some of this content may also be accessible to deployment engine 230. At least one embodiment of design engine 220 can include an element editor module 221, a policy editor module 222, a model editor module 223, a process editor module 224, and a policy manager module 225. Deployment engine 230 can include a provisioning module 231, a monitoring module 232, a redeployment module 233, and a policy manager module 235. Servers 210(1) and 210(2) can also include respective processors 227 and 237 and respective memory elements 228 and 238. Before discussing potential flows associated with the architectures of FIG. 1-2, a brief discussion is provided about some of the possible infrastructure that may be included in intelligent automation system 100.

Networks 205 and 275 represent a series of points or nodes of interconnected communication paths for receiving and transmitting network traffic that propagates through intelligent automation system 100. Networks 205 and 275 offer a communicative interface between nodes, and may be any local area network (LAN), wireless local area network (WLAN), metropolitan area network (MAN), Intranet, Extranet, wide area network (WAN) (e.g., the Internet), virtual private network (VPN), any other appropriate architecture or system that facilitates communications in a network environment, or any suitable combination thereof. Networks 205 and 275 may implement a communication messaging protocol that uses a multi-layered scheme such as Open Systems Interconnection (OSI) model, or any derivations or variants thereof (e.g., Transmission Control Protocol/Internet Protocol (TCP/IP), user datagram protocol/IP (UDP/IP)). However, networks 205 and 275 may alternatively implement any other suitable communication protocol for transmitting and receiving network traffic within intelligent automation system 100.

Network traffic sent and received within intelligent automation system 100 is inclusive of packets, frames, signals, data, etc. Also, the term ‘data’ as used herein, refers to any type of binary, numeric, voice, video, textual, media, or script data, or any type of source or object code, or any other suitable information in any appropriate format that may be communicated from one point to another in electronic devices and/or networks. Additionally, messages, requests, responses, queries, and input are forms of network traffic, and therefore, may comprise packets, frames, signals, data, etc.

In an example implementation, intelligent automation system 100 could be deployed by a service provider, with access to design engine 220 being provided to customers (e.g., network designers, cloud architects, etc.). In another example implementation, design engine 220 could be hosted in a domain close to network designers of a customer, and deployment engine 230 could be hosted in a domain close to a point-of-delivery (POD) to minimize network latency. In yet another example, both design engine 220 and deployment engine 230 could be hosted in the same server close to the POD, or in physically proximate servers. In yet another example implementation, design engine 220 and deployment engine 230 could be deployed by an enterprise in their own data center (in the same or separate servers).

Users of design engine 220 and deployment engine 230 are users wishing to initiate a communication in intelligent automation system 100 via some network. Design engine 220 could be associated with an end user who designs network solutions, in the form of models, for the enterprise. Deployment engine 230 could be associated with an end user who provisions models provided by the design engine. For example, an end user of design engine 220 could potentially be an Information Technology (IT) administrator of a particular enterprise, and the end user of deployment engine could be a network operator of a service provider. In another example, the end user of design engine 220 and the end user of deployment engine 230 could be associated with the same enterprise and may design, provision, and manage a private data center of the enterprise. These aforementioned deployments and users associated with intelligent automation system 100 are merely illustrative of possible implementations and are not intended to be limiting, as any number of potential deployments and users of various entities could be associated with intelligent automation system 100 according to the present disclosure.

Servers 210(1) and 210(2) hosting design engine 220 and deployment engine 230, respectively, are network elements that facilitate the model-based approach to intelligent automation of intelligent automation system 100. As used herein, the term ‘network element’ is meant to encompass servers, routers, switches, gateways, bridges, loadbalancers, firewalls, proxies, processors, modules, or any other suitable device, component, element, proprietary appliance, or object operable to exchange data in a network environment. Servers 210(1) and 210(2) may include any suitable hardware, software, components, modules, interfaces, or objects that facilitate the operations thereof. This may be inclusive of appropriate algorithms and communication protocols that allow for the effective exchange of data or information. Servers 210(1) and 210(2) may be separate devices in certain implementations (e.g., when design engine 220 is physically closer to a customer and when deployment engine 230 is physically closer to a point-of-delivery such as the service provider's data center). In other implementations, design engine 220 and deployment engine 230 may be co-located on a single server (e.g., when intelligent automation system 100 is implemented in a private data center of an enterprise). Servers 210(1) and 210(2) may also be any device that seeks to initiate a communication on behalf of another entity or element, such as a program, a database, or any other component, device, element, or object capable of initiating an exchange within intelligent automation system 100.

In at least one embodiment, servers 210(1) and 210(2) include software to achieve (or to foster) the model-based approach to intelligent automation, as outlined herein. Note that in one example, servers 210(1) and 210(2) can each have an internal structure (e.g., processors 227, 237, memory elements 228, 238, etc.) to facilitate some of the operations described herein. In other embodiments, these intelligent automation functions may be executed externally to these elements, or included in some other network element to achieve this intended functionality. Alternatively, servers 210(1) and 210(2) may include this software (or reciprocating software) that can coordinate with other network elements in order to achieve the operations, as outlined herein. In still other embodiments, one or several devices may include any suitable algorithms, hardware, software, components, modules, interfaces, or objects that facilitate the operations thereof.

User systems 215(1) and 215(2) may be inclusive of any computer configured to enable user input and communication between users and servers 210(1) and 210(2). User systems 215(1) and 215(2) can include suitable interfaces to a human user, such as a display, a keyboard, a mouse, a touchpad, a remote control, or other terminal equipment configured to facilitate communication of information from and to the user. User systems 215(1) and 215(2) can include, for example, personal computers, laptops, user workstations, terminal stations, tablets, mobile devices, etc.

Various data may be stored in databases or any other suitable storage structures that are internal to servers 210(1) and 210(2) or external (entirely or in part). Storage structures containing at least some of the data used in intelligent automation system 100 are represented by service elements database 212, models database 214, processes database 216, and policies database 218 in FIG. 2. Internal storage could include any internal memory of servers 210(1) and 210(2), such as static storage, random access memory (RAM), or cache, for example. External storage could include a network storage technique such as network attached storage (NAS) or storage area network (SAN), or the internal memory of another network element, for example.

Design engine 220 of server 210(1) provides a user with the ability to design content without knowing how the content is ultimately deployed by deployment engine 230. Through design engine 220, a user (e.g., a cloud architect) can create service elements, processes, and policies, and can use these reusable service components to compose a model that defines a desired service. In some instances, a model can be used as a sub-model with one or more other reusable service components to compose a composite model. In at least one embodiment, a user can perform one or more of these content design activities via a graphical user interface (GUI) on a display of a user system communicating with server 210(1), remotely or locally. In at least one embodiment, these content design activities may be facilitated, at least in part, by element editor module 221, policy editor module 222, model editor module 223, process editor module, 224 and/or policy manager module 225. Information related to the content design activities can be suitably rendered, or sent to a specific location (e.g., deployment engine 230, etc.), stored or archived (e.g., service elements database 212, models database 214, processes database 216, policies database 218, etc.), and/or properly displayed in any appropriate format (e.g., via a user interface on a display of user system 215(1)). Service elements database 212, models database 214, processes database 216, and policies database 218 may include information related to the content design activities and these elements can readily cooperate, coordinate, or otherwise interact with the modules and components of design engine 220.

Deployment engine 230 of server 210(2) provides a user with the ability to deploy a service model to a selected target (e.g., a virtual data center). Through deployment engine 230, a user (e.g., a network operator) can select a target for a service model, and the service model can be provisioned into a model instance on one or more endpoints of the target. Additionally, the model instance can be monitored and when certain policies are violated, in some scenarios, remedial actions may be taken and the model may be redeployed in whole or in part without modifications to the model itself. In other scenarios, the model can be modified and redeployed. In at least one embodiment, a user can perform one or more deployment activities via a graphical user interface (GUI) on a display of a user system communicating with server 210(2), remotely or locally. In at least one embodiment, deployment activities may be facilitated, at least in part, by provisioning module 231, monitoring module 232, redeployment module 233, and/or policy manager module 235. Information related to the deployment activities can be suitably rendered, or sent to a specific location (e.g., design engine 220, endpoints of targets 240 etc.), stored or archived, and/or properly displayed in any appropriate format (e.g., via a user interface on a display of user system 215(2)). Service elements database 212, models database 214, processes database 216, and policies database 218 may include information related to the deployment activities and these elements can readily cooperate, coordinate, or otherwise interact with the modules and components of deployment engine 230.

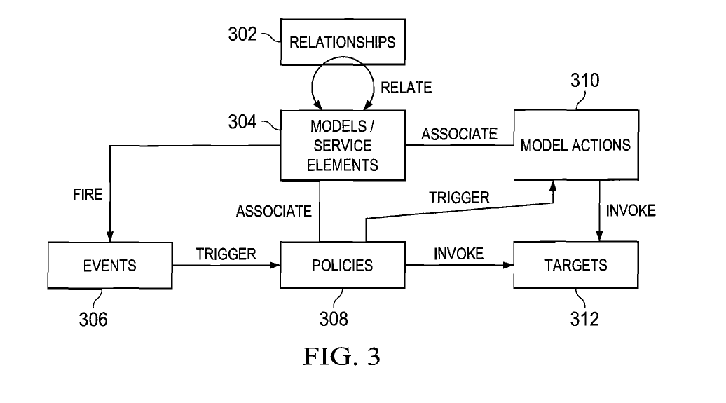

Turning to FIG. 3, FIG. 3 illustrates components used in intelligent automation system 100 to express desired states of services, actions, and deployment. Components can include relationships 302, models and service elements 304, events 306, policies 308, model actions 310, and targets 312. Generally, relationships 302 can relate service elements to each other, sub-models (i.e., models within a higher level service model) to each other, and service elements to sub-models. Models and service elements 304 may be associated with policies 308 (e.g., element-level policies associated with service elements, model-level policies associated with models), and model actions 310. Models and service elements 304 can fire (or generate) events 306, during composition, deployment, and/or runtime. Events 306 are occurrences that can be evaluated based on a condition. Depending upon the result of a condition evaluation, the event can trigger policies 308. When a policy is triggered (i.e., a condition is met), then one or more model actions 310 may be triggered. Model actions 310 and policies 308 can invoke targets 312, in which models have been deployed.

With reference now to preceding FIGS. 1-3, the components shown in FIG. 3 will be further described in more detail. Service elements are elemental-level objects that can be used alone or in combination to create a model. Service elements are the lower level, or leaf entities of a solution, and can include compute elements, storage elements, and networking elements. Particular examples of service elements include, but are not limited to, application elements, security elements, and database elements. A service element may be defined with strong typing (e.g., a Centos-Linux virtual machine, an Apache web server, etc.). A service element may also include attributes that describe the configuration of the service element. For example, attributes of an Apache web server can include an IP address when the server is deployed to a data center of a network, a name of the web server, and connectivity to a particular database the Apache webserver is going to use. In another example, attributes of a database can include a database name, a data content name, a host, a database type, and a connection. Attributes of a service element can be user-specified values, default values, automatically generated values, or any suitable combination thereof. In at least one embodiment, service elements may be stored in service elements database 212, and the creation and modification of service elements may be facilitated, at least in part, by element editor module 221.

A model is a declarative specification that describes an automation goal in terms of a desired state, and relationships of elemental level objects to fulfill a service, or other solution. Some models can be composed at a higher level and can describe relationships of sub-models, service elements, or any suitable combination thereof. A service is one example of a solution. In at least one embodiment, a model can be composed by a user and stored in models database 214. The composition and modification of models may be facilitated, at least in part, by model editor module 223. Through a model, a user can specify what he wants to occur in data and define a desired state of a service through a collection of related objects (i.e., service elements, sub-models). The models describe the overall/high level plan of the service (or other solution), which drives the automation to achieve the end goal by decomposing the complex top level service into finer grained actions against the elemental level objects of the service. For example, a model to prescribe a virtual application (vApp) for holiday shopping could be made of an Apache web server, which uses an XYZ database, both of which can be hosted on a Centos Linux virtual machine (VM). The model-based approach enables a user to focus on defining the topology, relationships, and data for each elemental level object (e.g., Apache web server, XYZ database, Centos Linux VM) of the service without knowing how the service is created.

A model provides a unified abstraction to define services or other solutions. A model can include a collection of objects, which have relationships to one another to facilitate a specific service. Thus, in one example, a model can be a composition of multiple service elements and the relationships between those service elements. In another example, a model can be a composition of multiple sub-models and the relationships between those sub-models. In yet another example, a model can be a composition of one or more sub-models and one or more service elements and the relationships between those objects. A model can be defined with strong typing on the model level, which can be specified at design time (e.g., vApp-Apache-XYZ, VDC-san-jose, etc.). A user can design (or compose) a model by creating desired service elements and/or sub-models for the model or by using existing service elements and/or sub-models that have already been defined. A model may have one or more properties that can be user-specified values, default values, automatically generated values, or any suitable combination thereof.

Services of a model may be created for various purposes and the model may apply to different domains or to a single domain. Examples of models with particular purposes include, but are not limited to, a resource model, a performance model, and an organization model. The service elements comprising the resource model (or sub-model) can be resource-oriented. These service elements can form a set of interdependent resources (e.g., an Apache web server uses an XYZ database or a pooled resource, such as an IP address pool). Resource models are typically authored to define a combination of services including, but not limited to, compute, network, storage, and application services.

In a performance model (or sub-model), service elements can be metrics-oriented. A performance model can capture key performance indicators (KPIs), relationships between the KPIs, and formula and data/event sources for computing the KPIs. Performance models are typically authored to define health monitoring to track the time periods for CPU utilization (e.g., high and low) and the cost of services for most CPU resources.

An organization model (or sub-model) can include service elements that are entity-oriented. An organization model can capture the structure of the organization (e.g., service provider having multiple tenants, each tenant having sub-tenants, and each tenant having multiple departments and associated members). Workgroups or roles (e.g. operator, administrator, etc.) can be defined for each user to control access. For example, role-based access control (RBAC) may be used to restrict system access to certain resources within the tenant to authorized users.

Model composition provides users with the capability of creating reusable services in either top-down or bottom-up approaches. In at least one embodiment, these reusable services may be composed by a user via one or more user interfaces, for example, of user system 215(1). In a bottom-up approach, lower-level objects (e.g., service elements) are composed first. The objects can have relationships to other objects, enabling the composition of a service model to unify a collection of related service elements to define one or more services. The relationships may be specified by a user. The models can be composed as sub-models to create a higher level model. In a top-down approach, higher-level services (e.g. customer relationship management (CRM) services) are composed first. Other models may be included as sub-models inside the higher-level service. Thus, other models can be reused as library components when creating larger models. In at least one embodiment, model composition can be highly structural and hierarchical.

Relationships between objects (e.g., between service elements of a model, between sub-models of a higher level model, between sub-models and service elements of a higher level model, etc.) can either be predefined (e.g. uses, hosted by, deployed, etc.) or customized by a user (e.g. employed by, triggers, etc.). Relationships have properties to capture metadata for the relationship between two objects. The cardinality can also be specified and managed (e.g. 1-to-1, 1-to-many, many-to-many, etc.).

Model composition also supports inheritance. A base abstract type of service element, like a web server, can be inherited by a more specific concrete type of service element, like an Apache web server that has additional properties and actions. A concrete type can have full access to the properties and actions of its parent (the abstract type). Inheritance support not only provides re-usability, but also creates standardization. Standard properties, policies, and/or actions can be defined in base abstract types from which all other extended types inherit. Examples of properties, policies, and/or actions that may be standardized in this manner include, but are not limited to, unique standard names (e.g. Information Technology Infrastructure Library (ITIL) name), display names, versions, descriptions, workflow actions (e.g., create, read, update, and delete (CRUD)), validation, and role-based access control (RBAC) policies.

Models drive model actions to achieve the end goal of automation. Model actions can be executed at both the model level and the service element level. Typically, in intelligent automation, model actions are realized by workflow processes (also referred to herein as simply ‘processes’) that define possible orchestration actions against the service models. Model definitions and/or service element definitions (or types) that a process can accept can be constrained so as to define which process can act against it. More specifically, as part of process creation, each process is specified with a set of model types that are accepted by the process and the process is designed to handle the specified set of model types.

In at least one embodiment, processes associated with service elements (also referred to herein as ‘element-level processes’) and/or processes associated with models and sub-models (also referred to herein as ‘model-level processes’) can be stored in processes database 216. Process creation and modification may be facilitated, at least in part, by process editor module 224. Element-level processes can include processes doing elemental work on service elements such as initializing, creating, deleting, starting, stopping, pausing, rebooting, shutting down, configuring, cleaning up, updating, undoing/recovering, etc. At least some of these elemental-level processes are inherently provided in models to support the full lifecycle. Instead of operating as a ‘fire-and-forget’ system, models created according to embodiments of intelligent automation system 100 can maintain snapshots of entire life cycles through the model actions. This can be particularly beneficial for recovery actions when failures occur in the middle of actions and rollback to a previous snapshot is desired.

Model-level processes can include higher level operations that may be performed before or during deployment of the model, depending on the particular process. Model-level processes can also be configured to orchestrate the elemental-level processes of the associated model or sub-model within the model. In some instances, a model or sub-model may not have an associated model-level process. For example, if the model or sub-model is a simple implementation of a few service elements, in which only simpler low level processes (e.g., start, update, shutdown) are needed, then a model-level process may be unnecessary.

Deployment of a model involves provisioning the model in a target. When a model is being provisioned, deployment engine 230 can automatically traverse relationships between higher level service models and lower level service elements for which processes are run. Consider a vApp-Apache-XYZ model that comprises an Apache web server service element ‘using’ an XYZ database service element, with both service elements being ‘hosted on’ a Centos Linux VM service element. In this example, ‘using’ and ‘hosted on’ are the relationships created between the service elements. These relationships define the topology of the service model, which the automation is intended to achieve. Metadata properties can be associated with each relationship and define a set of known dependencies. Deployment engine 230 can traverse the relationships and heuristically derive an order of execution (e.g. provision Centos VM, then XYZ database, and last the Apache web server). This automated ordering, however, can be overridden with custom workflow processes (e.g. model-level process to follow certain industrial best practice). For example, in the example scenario, it may be desirable to provision the Apache web server first, then provision the XYZ database, or start the XYZ database with specific performance parameters.

The actual work to deploy a model is defined at the leaf entities (e.g., service elements). As models are defined at a higher level, however, fewer elemental processes may need to be defined at the lower level. In some instances, a user creating a model may not define any processes at leaf entities (i.e., lowest level). In these cases, the user may not be concerned with the particular service elements used to implement the model.

In other cases, where the user desires particular service elements for a solution, the user can first define a service element (e.g., a web server). After defining the service element, the user can specify attributes for the service element. Then, the user can define processes for the service element. Typical processes to be created include create, update, and shut down processes for the service element. The user can then create a model that includes the web server and a database, for example. The database service element can have its own processes (e.g., create, update, and shutdown). When the user creates a relationship between the service elements, the model is created.

If anything special is desired before deploying the database server and webserver, then a high level process can be created to run the model. An example of a high level process could be evaluating a virtual data center before the model is deployed to determine whether the data center has enough resources to accommodate the particular model. This high level process could be created at the model level. If only basic processing is needed (e.g., start, shutdown, and update), however, then the user may create the model without any model-level processes.

In some scenarios, during deployment, a model-level process can be executed first. The model-level process can orchestrate the different service element processes. If a model-level process does not exist, however, then deployment engine 230 can determine which ones of the service element processes to execute and the order of execution, based on the relationships defined in the model.

This model-based approach of intelligent automation provides clear separation of the content (‘What’) from the deployment (‘How’). It enables the iterative development process that one starts from designing the content required by a desired goal without needing to know how the particular solution is deployed at the end. In accordance with at least one embodiment, deployment elasticity of intelligent automation system 100 enables redeployment of the same solution to a different environment (e.g. redeploy a private virtual data center (VDC) solution to a cloud computing service provider for workload distribution). Additionally, a solution may be modified and redeployed for requirement and/or versioning evolution. Thus, intelligent automation system 100 is configured to dynamically support new solutions, for example, when policies change or when new versions of models or service elements are required (e.g., based on business needs, etc.).

A connection or contract between a model and how it is deployed can be specified either via early binding or late binding. A user can specify certain deployment targets on which a model is to be deployed (e.g., specify a virtual data center (vCenter) at the design time for early binding). Targets specified for early binding, however, can be overridden during deployment as long as they are the same type and authorizations (if any) are verified. Furthermore, if no targets are specified at design time for early binding, then targets may be specified during deployment time for late binding. A binding connection can specify types of targets for the deployment, parameters required to invoke the target, user identity, etc. The particular automation needs of a model can dictate whether early binding is provided at design time or whether late binding is provided at deployment time. For example, late binding can be more relevant to deployment targets that maintain workload balancing. In this scenario, the decision is derived dynamically at deployment time to select a deployment target with the best capacity level.

Intelligent automation system 100 provides policy management that enables separation of policy concerns from automation logic. Policy management can simplify design, deployment and runtime when policies are expressed for either a specific aspect or cross cutting concerns. For example, a validation policy could be expressed for a specific aspect (e.g. a requirement that an Apache web server needs to be 2.x or newer for vApp-Apache-XYZ model). In another example, a cross cutting policy could be expressed to require stopping all automation actions as a cross-cutting concern when the memory utilization is over 90%. Some policies can be configured as a set of guidelines to fulfill the service. For example a range of capacity (e.g., 4 GB to 16 GM RAM), or a gold/silver/bronze categorization (e.g., the categorization determines the particular set of servers in which a model is deployed) may be specified with the service model. In the first example, the service request can be realized if the capacity is acquired within the range defined by the policy. In the second example, the service request can be realized by deploying the model to the network elements allowed by the selected categorization.

In at least one embodiment, policies can be created by a user and stored in policies database 218. The creation and modification of policies may be facilitated, at least in part, by policy editor module 222. Policy management can include the application of policies to service elements, models (and sub-models), and processes; the evaluation of policies to determine whether violations have occurred; and the initiation of policy actions in response to policy violations. At least some aspects of policy management of intelligent automation system 100 may be provided by policy manager module 225 of design engine 220, and policy manager module 235 of deployment engine 230.

Policies can comprise rules to govern a set of actions related to models, service elements, and/or model instances. A policy can be grouped into a policy set for a particular interest and may or may not be nested. A policy or policy set can be associated with one or multiple models and service elements with either a condition or compound conditions. When a condition(s) is true, policies are triggered which in turn initiate policy actions. The uniqueness of policy actions enables business extensions for the policies completely outside the processes because they are distinct concerns that can be managed separately. Policy actions can include, but are not limited to, starting a process, invoking an activity (e.g., sending an email, sending a text message, creating an alert, etc.), correlating events, executing scripts, and firing new events.

Policies or policy sets can be associated with events which enable the expression of the cross cutting concerns. Events can come from various sources. When an event occurs, the condition evaluation against the event takes place. If the condition evaluation is true, the corresponding policies are triggered. Different types of events can come from various sources and can include, but are not limited to, external events through adapters (e.g. Simple Network Management Protocol (SNMP) traps, vCenter events, etc.), model events, life cycle events of a service model (e.g. Create, Re-configure, Delete, Reboot, etc.), and scheduler events (e.g. time-based triggers, etc.).

Events can also serve as important building blocks for automation extensibility. Through events, both cross-cutting and model specific concerns can be addressed. For example, expansion automation can be triggered when low capacity events are raised. Even during the automation process, based on different events raised (e.g., through validation), the automation can take different paths.

Policies implemented in intelligent automation system 100 can be categorized in one of at least three high level types of policies (as shown in FIG. 1): design policies, deployment policies, and runtime policies. Design policies may include any policy that is related to content of any kind used in a model. The actual policy may include any rule(s), command(s), instruction(s), requirement(s), protocol(s), framework(s), etc. for carrying out some course of action based, at least in part, on certain content. For example, a validation policy may be a type of design policy in which a particular type of content is required and the requirement is expressed within a model. In a specific illustration, a validation policy could be a requirement specified at the model-level that an Apache web server is a 7.0 or higher version. Therefore, if the model is created with a service element that does not meet this policy requirement (e.g., a 6.0 version Apache server), then the server will not run within the service model. Accordingly, a user request to add (e.g., by dragging and dropping) a 6.0 version Apache server to the service model may be denied and an error message may be displayed to the user. A dependency policy can also be a design policy, and is expressed in terms of relationships. An illustrative dependency policy, specified at the element-level, could be an Apache web server that depends on an XYZ database that is a 10.0 or higher version. In this example, when a user requests a relationship be created between an Apache web server and an XYZ database, then if the XYZ database is a 9.0 version, the relationship request is denied and an error message may be displayed to the user.

Deployment policies may be provided to validate various aspects of a model and the service elements, sub-models, and relationships within the model during provisioning, before the model is actually deployed to a target. A dependency policy can be a deployment policy in some scenarios. For example, consider the previous dependency policy of an Apache web server depending on an XYZ database that is a 10.0 or higher version. In this example, when the model (with the Apache web server and XYZ database) is being deployed to a target, if a 9.0 version XYZ database is selected, for example, if a user overrides the 10.0 version XYZ database, then a policy violation can occur and the selected 9.0 XYZ database will not run within this model.

Runtime policies may be applied to a model to ensure that a model instance (i.e., a deployed model) complies with desired policies during runtime. An example runtime policy could be a restriction on the amount of memory that can be used by a virtual machine during runtime (e.g., 90% memory utilization maximum) in order to maintain a desired level of performance. A runtime policy action could be sending a notification to policy manager module 235 if the memory utilization exceeds the maximum amount specified by the policy to alert policy manager module 235 that the memory is saturated. When the policy manager module receives the notification, a determination could be made as to whether the particular policy violation could be corrected without modifying the model. For example, in this scenario, policy manager module 235 could provide instructions to provision another set of memory for the virtual machine to improve its performance. Runtime policies enable constant monitoring of a model instance and thus, the entire life cycle of the service can be managed.

Embodiments of the model-based approach of intelligent automation system 100 enable life cycle management of solutions. Rather than providing one-time provision actions (also referred to as ‘fire-and-forget’), intelligent automation system 100 allows progressive monitoring of model instances, re-configuration of models, and re-provisioning of models. In at least one embodiment, monitoring module 232, provisioning module 231, and redeployment module 233 can perform at least some of these activities. Life cycle states can be preserved and managed. Each life cycle state of a model is associated with a set of actions which can run against the model or model instances. For example, actions for running a Centos Linux VM instance could include power on, power off, reboot, re-provision, and re-configure.

Centralized policies can be used to govern the entire life cycle of the service, including service creation, service deployment, and operation monitoring. For example, an ‘approval policy’ based on a range of capacity for a tenant may reduce the need of change requests if the deployment (or redeployment) of resources are consistent with the policy. Other policies include validation policies to ensure the dependency to certain service elements (e.g., tomcat 7.x, security policies for RBAC, etc.).

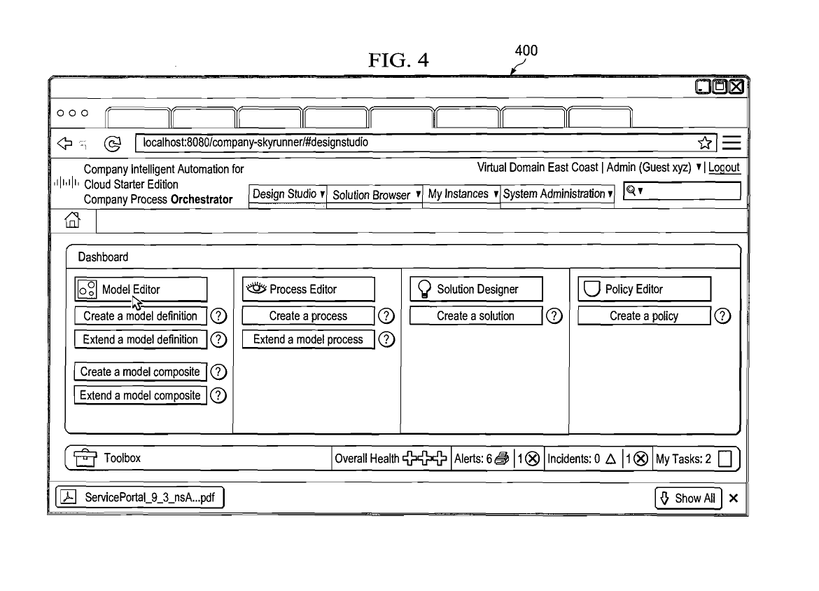

Turning to FIGS. 4-13B, various example screen shots and flowcharts of possible operations associated with intelligent automation system 100 are illustrated. FIG. 4 is a screen shot 400 of a example dashboard that may be associated with various functions of intelligent automation system 100, and that may be displayed on a display screen of a user system, such as user system 215(1). In at least one embodiment, the dashboard can be associated with one or more functions of design engine 220. The dashboard in screen display 400 includes a model editor option, a process editor option, a solution designer option, and a policy editor option. The model editor option is configured to allow a user to manage model definitions for a single model (i.e., one or more service elements) or a composite model (i.e., at least one sub-model and possibly one or more service elements). The process editor option is configured to allow a user to manage processes. The solution designer option is configured to allow a user to view solutions, including models that were previously composed. The policy editor option is configured to allow a user to manage policies.

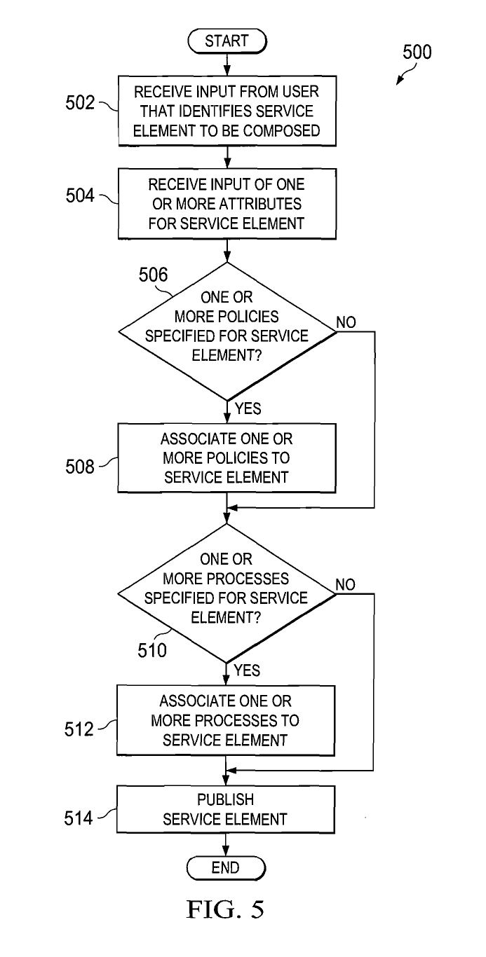

FIG. 5 is a flow chart illustrating activities that may be associated with a composing a service element in intelligent automation system 100 according to an embodiment. A set of operations may correspond to the activities of FIG. 5. In at least one embodiment, element editor module 221 of server 210(1) may perform at least some of the operations.

A flow 500 may begin at 502, where input is received from a user that identifies a service element to be composed. The identifying input could be a unique identifier such as a distinctive name of the service element. At 504, input representing one or more other attributes of the service element may be received. By way of illustration, attributes of an Apache web server could include IP address and connectivity to a database, while attributes of a database could include a data center name, a host, a database type, and connection information.

As indicated at 506, if one or more policies are specified for the service element, then at 508 the one or more specified policies are associated with the service element. The specified policies for the service element can include one or more new policies created by a user or selected from previously defined, reusable policies. A policy can be expressed in terms of a requirement for a particular service element. For example, a policy could be expressed as a requirement that an Apache service element can only be created if it is dependent on an XYZ database version 10.0 or newer. Another policy could be expressed as a requirement that the Apache server can only run on a particular type of machine. Generally, these policies can be business rules expressed by a designer of the solution.

As indicated at 510, if one or more processes are specified for the service element, then at 512 the one or more processes are associated with the service element. The specified processes can be created by a user or selected from existing, reusable processes. An element-level process could be a process that performs elemental work for the associated service element. For example, common element-level processes include separate processes to initialize, clean up, configure, create, delete, start, stop, pause, reboot, and shut down a service element. At 514, the service element may be published. In at least one embodiment, publishing the service element includes storing it in service elements database 212 so that it can be reused when other models are being composed.

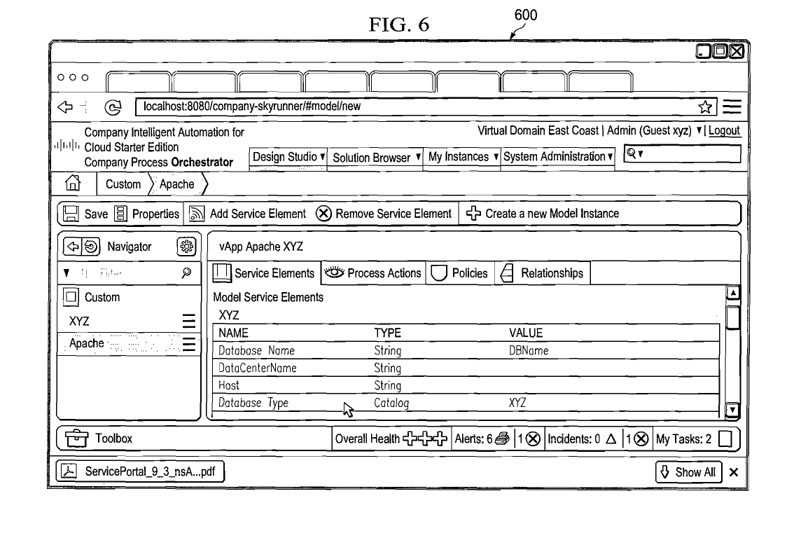

FIG. 6 is a screen shot 600 of example information that may be displayed on a display screen of a user system when a selection is made to view a model's service elements, in at least one embodiment. In this illustrative example, information associated with two service elements, an XYZ database and a Apache web server, may be displayed for a model named ‘vApp Apache XYZ’. The attributes of each service element may be displayed, including for example, the name of the attribute, the type of the attribute, and the value of the attribute.

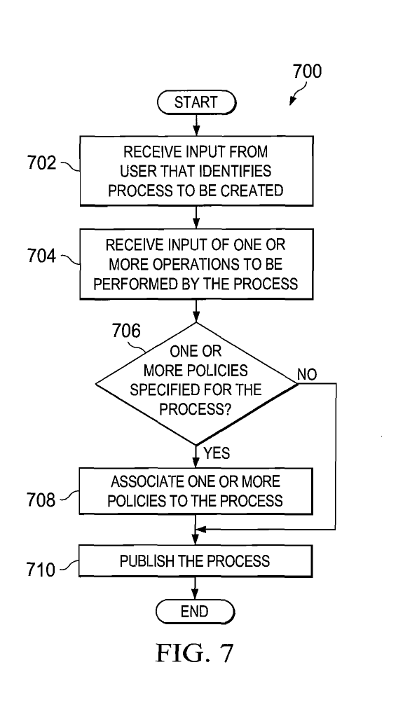

FIG. 7 is a flow chart illustrating activities that may be associated with creating a process in intelligent automation system 100 according to an embodiment. A set of operations may correspond to the activities of FIG. 7. In at least one embodiment, process editor module 224 of server 210(1) may perform at least some of the operations.

A flow 700 may begin at 702, where input is received from a user that identifies a process to be created. The identifying input could be a unique identifier such as a descriptive name of the process. At 704, input representing operations to be performed by the process may be received by the user. Operations may also include conditional logic.

Processes may be created for a service element (element-level processes) or for a model (model-level processes). Element-level processes can perform elemental work on the service element (e.g., initialize, clean up, configure, create, delete, start, stop, pause, reboot, shut down, etc.). Model-level processes can include processes to orchestrate the element-level processes and/or higher model-level processes to perform other functions related to the model (e.g., evaluating whether a data center has enough resources to accommodate the model).

As indicated at 706, if one or more policies are specified for the process, then at 708 the one or more specified policies are associated with the process. The specified policies for the process can include one or more new policies created by the user or one or more previously defined, reusable policies. A policy can be specified in terms of a requirement for a particular process. At 710, the process may be published. In at least one embodiment, publishing the process includes storing it in processes database 216 so that it can be reused when service elements or models are being composed.

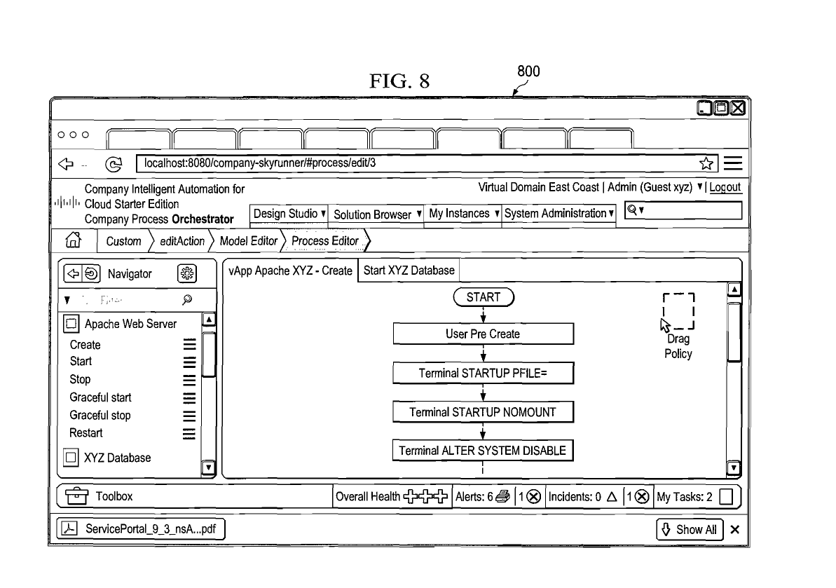

FIG. 8 is a screen shot 800 of an example process that may be displayed on a display screen of a user system when a selection is made via a graphical user interface to view a ‘start’ process for an XYZ database. The boxes represent at least some of the operations (e.g. ‘User Pre Create’, ‘Terminal STARTUP PFILE=’, etc.) to be performed during execution of the process. In at least one embodiment, the operations may be dragged and dropped into the process flow using an appropriate input mechanism (e.g., mouse, finger, touchpad, etc.). Additionally, conditional logic may also be added, when needed.

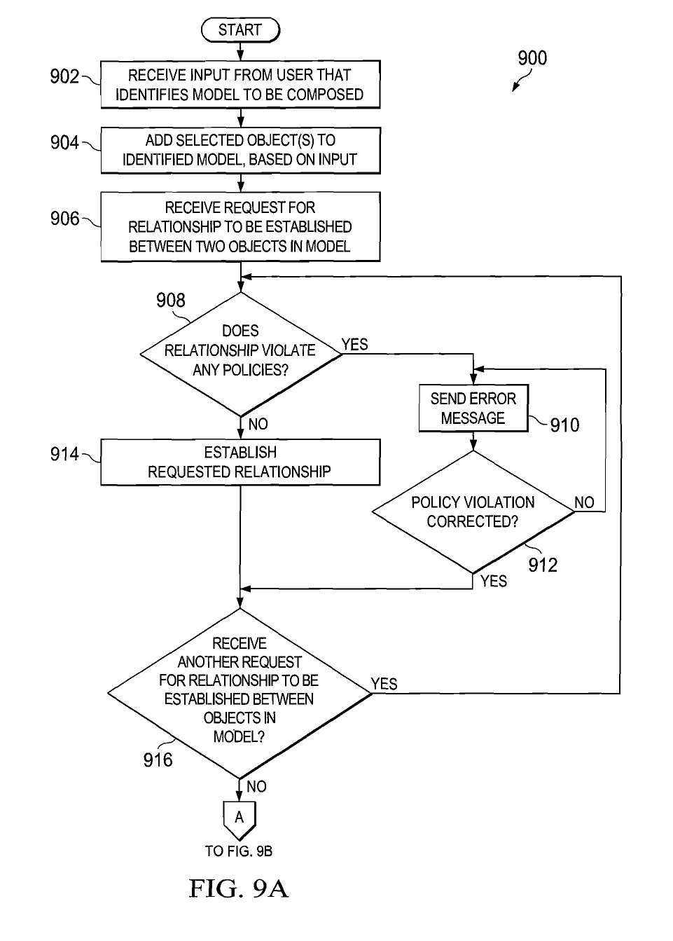

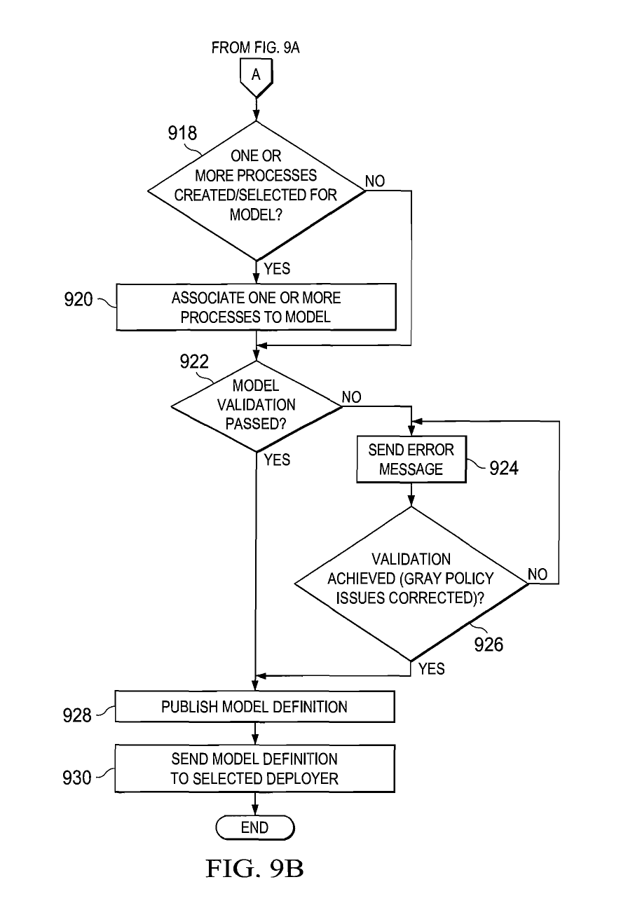

FIGS. 9A and 9B are flow charts illustrating activities that may be associated with composing a model in intelligent automation system 100 according to an embodiment. A set of operations may correspond to the activities of FIGS. 9A and 9B. In at least one embodiment, model editor module 223 of server 210(1) may perform at least some of the operations.

A flow 900 may begin at 902, where input is received from a user that identifies a model to be composed. The identifying input could be a unique identifier such as a distinctive name of the model. At 904, one or more objects (i.e., service elements and/or sub-models) can be added (e.g., dragged and dropped via a graphical user interface) to the model being composed. The model being composed is a composite model when the objects added at 904 include at least one sub-model. Generally, in some instances a model can be N-dimensional because different aspects of models can be combined in a single service request. For example, a virtual application shopping service model can have an entity model for all of the service elements and dependencies, SLA model, and organization model for users/RBAC, etc.

At 906, a request may be received for a relationship to be established between two objects added to the model. The relationship can express the association between two service elements, between two sub-models, or between a service element and a sub-model. Examples of relationships between service elements can include, but are not limited to, ‘uses’, ‘hosts’, ‘invokes’, ‘inherits from’, and ‘is deployed in’. The relationship can be expressed on the infrastructure layer rather than just the operation layer, and applications can be overlaid on top of the infrastructure. Thus, the expression of relationships is a layering concept and tiers may be created (e.g., top tier is a firewall, middle tier is a web server, and third tier is an application server running a desired application). Multiple nodes may be created within each tier depending on particular needs (e.g., loadbalancing).

At 908, a determination is made as to whether the requested relationship violates any policies. One or more policies may be specified for one or both of the objects of the requested relationship. If the relationship violates any of those policies, then an error message may be sent at 910. In at least one embodiment, the error message may be provided to a user via a graphical user interface on a display screen of a user system. If the policy violation is not corrected as determined at 912, then additional error messages may be sent at 910. If the requested relationship does not violate any policies, as determined at 908, then the relationship can be established at 914.

At 916, a determination is made as to whether another request has been received for a relationship to be established between objects in the model. If so, then flow 900 can loop back to 908, to determine whether any policies of the objects are violated. Accordingly, for each request to establish a relationship, a determination is made as to whether the relationship violates any policies. If no policies are violated, then the relationship can be established, but if a policy is violated, the relationship may not be established. In some scenarios, however, a policy may not be violated, but the condition of the policy may be indeterminable (e.g., when a variable is unknown), as will be further described herein. In this scenario, a policy may trigger an alert message to a user, but may nevertheless allow the relationship to be established.

At 918, a model-level process may be created by a user or selected from pre-existing processes for the model. A model-level process could be a process that orchestrates all of the lower level processes associated with the service elements. For a model composed of one or more sub-models, the model-level process associated with the model could also orchestrate other model-level processes, if any, associated with the one or more sub-models. Other higher model-level processes may perform actions associated with the model itself (e.g., checking to see if there is enough capacity at a data center for the particular model). If a model-level process is created or selected, then it may be associated with the model at 920.

In at least one embodiment, once the model has been defined, a validation check may be performed on the model. In some instances, a variable may be applied to a service element and the value may be based on some other service element (e.g., a constant applied to another service element), or it could be based on based on targets and deployment configurations. In these scenarios, the value of the variable may not be known during at least a portion of time when the model is being composed. Some validation could be performed during the composition, such as validating the variable type. The validation of the variable itself, however, is a gray area until its value becomes known. If the value is based on a constant from some other service element, then validation of the variable can be performed once the model has been composed (or whenever the constant is added to the model). Accordingly, at 922, a determination is made as to whether a model validation has passed. If the model validation does not pass, then an error message can be sent at 924. In at least one embodiment, the error message may be provided to a user via a graphical user interface on a display screen of a user system. Model validation may not pass if variables that are based on other service elements are not resolved. If validation is not achieved as determined at 926, then additional error messages may be sent at 924. Validation may be achieved by resolving the unresolved variables in the model in one example. In at least one embodiment, variables could be applied to sub-models. Moreover, the value of any variable could be based on a sub-model or service element other than the sub-model or service element to which the variable is applied.

If all of the variables are resolved at 922, or if the unresolved variables cannot be resolved until deployment, or if validation is achieved at 926 after initially failing, then the model definition can be published at 928. In at least one embodiment, publishing the model definition includes storing it in models database 214 so that it can be accessible to users for reuse (e.g., when composite models are being composed, when the model is being modified, etc.). The model definition describes the desired state of the service, which includes not only objects and dependencies, but can also include operational attributes of the infrastructure (e.g., capacity, service-level agreement (SLA), health, etc.). The model can be updated in near real-time to ensure the most accurate version of a desired service is deployed. This is particularly important in a cloud/elastic environment where services are frequently changed to meet business needs. The model definition may be sent to a selected deployer at 930, in order to deploy the model based on the model definition.

While flow 900 indicates that objects, relationships, and processes are added to the model consecutively, this is done for illustrative purposes only. In at least one embodiment, intelligent automation system 100 is designed to allow flexibility when composing a model. Accordingly, service elements, sub-models, relationships, and processes may be added in any appropriate desired sequence. For example, two service elements may be added and then a relationship may be requested. Subsequently, another service element may be added and then other relationships may be requested between the new service element and the previously added service elements. A process could be added to the model at any time.

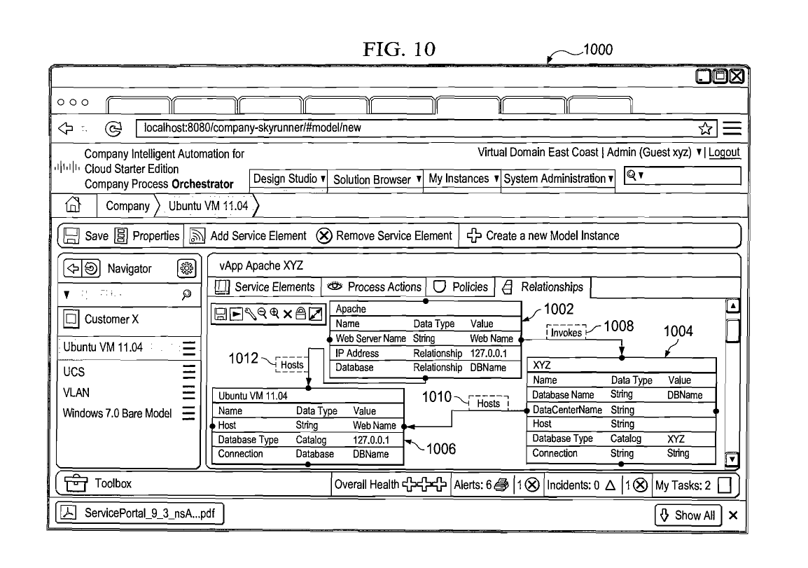

FIG. 10 is a screen shot 1000 of an example model composition that may be displayed on a display screen of a user system when a user is composing a model via a graphical user interface. For example, a user may select the ‘model editor’ option on the dashboard to compose a model. Service elements 1002, 1004, and 1006 represent an Apache web server, an XYZ database, and an Ubuntu virtual machine, respectively. In at least one embodiment, each of these service elements 1002, 1004, and 1006 may be dragged and dropped into a designated area of a graphical user interface as shown, using an appropriate input mechanism (e.g., mouse, finger, touchpad, etc.). These service elements may be offered as options to the user, for example, in the ‘Navigator’ pane. An ‘invokes’ relationship 1008 is established between the Apache web server and the XYZ database. In at least one embodiment, this relationship may be requested when a user draws a line from the Apache web server service element 1002 to the XYZ database service element 1004 using an appropriate input mechanism (e.g., mouse, finger, touchpad, etc.) via the graphical user interface. Assuming no policy violations are detected, the relationship can be established. A default relationship may be shown initially, and the user may be able to click on the default relationship to select from a drop down box listing one or more other relationship options. A ‘hosts’ relationship 1010 is shown between the XYZ database and the Ubuntu virtual machine, and another ‘hosts’ relationship 1012 is shown between the Apache web server and the Ubuntu virtual machine. Relationships 1010 and 1012 may also be requested when a user draws a line between the corresponding service elements, and they may be established if no policies are violated.

In at least one embodiment, policies specified for service elements 1002, 1004, and 1006 may be evaluated as the model is being composed. For example, if a policy is specified for Apache web server service element 1002 that requires an XYZ database that is version 10.0 or newer, then this requirement may be evaluated when the relationship is requested (e.g., when the user draws a line between the Apache web server and XYZ database service elements). If XYZ database service element 1004 is version 9.0, for example, then a policy violation can be detected and an appropriate action may be taken (e.g., an error message displayed on the graphical user interface). Thus, a user who is tasked with composing models for a particular entity can be alerted to incompatibilities or other problems based on a model's requirements and can take appropriate remedial measures before the model is deployed.

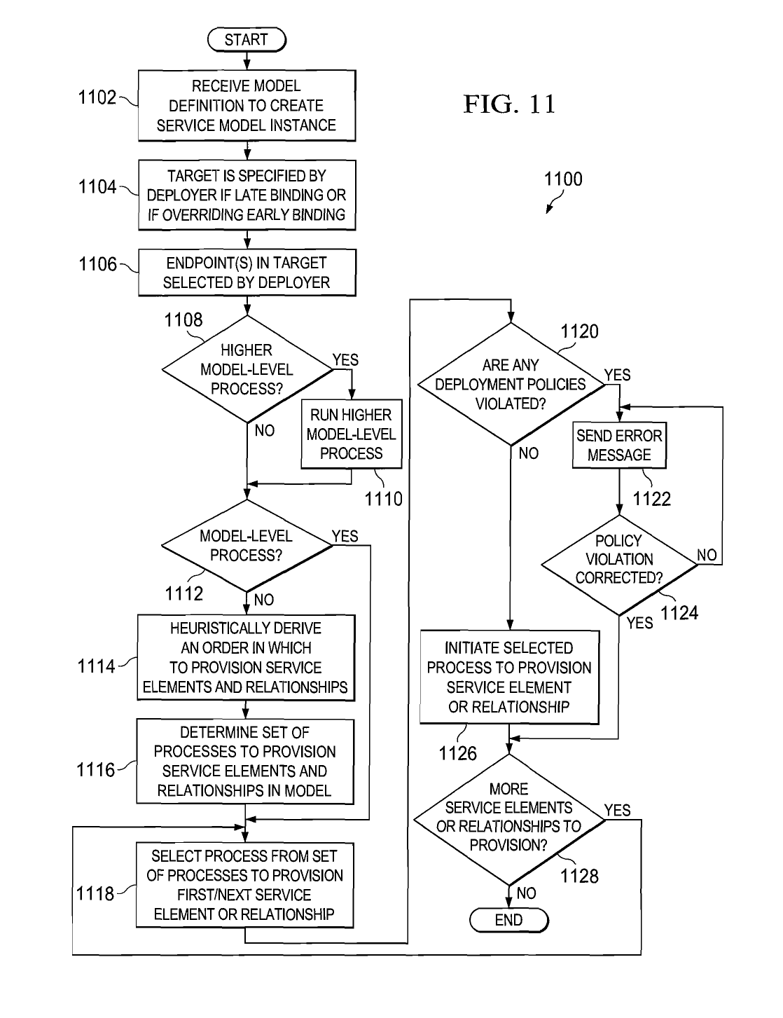

Turning to FIG. 11, a flow chart illustrates activities that may be associated with deploying a model to one or more endpoints in a target according to an embodiment of intelligent automation system 100. A set of operations may correspond to the activities of FIG. 11. In at least one embodiment, provisioning module 231 of server 210(2) may perform at least some of the operations.

A flow 1100 may begin at 1102, where a model definition is received from design engine 220 to create a service model instance. A service model instance is an instantiation of a model. A model definition of a model comprises detailed information associated with the model, which can be used to instantiate the model in one or more endpoints of a target.

Once a model definition has been received, a user (also referred to herein as ‘deployer’) may initiate one or more actions related to deployment of the model. At 1104, for example, if a target has not been specified for a model, a deployer may initiate late binding in which a target is specified for the particular model (e.g., San Jose data center). In at least one embodiment, the target could be a physical or virtual data center. If a target was specified for the model via early binding, however, then the deployer may not need to specify a target for the model. In some instances, however, a deployer may override early binding, and may specify a different target based on particular needs (e.g., overriding San Jose data center specified in early binding with San Francisco data center). At 1106, the deployer may specify at least one endpoint (e.g., a particular server set) in the target on which the model can be instantiated.

If a higher model-level process is associated with the model, as determined at 1108, then the process can be run at 1110. This process may or may not perform orchestration of the element-level processes associated with the service elements of the model. If a model-level process that performs orchestration of element-level processes is not associated with the model, as determined at 1112, then flow may pass to 1114. At 1114, deployment engine 230 can heuristically derive the order in which to provision service elements and relationships of the model. This order of execution can be derived by traversing (or evaluating) at least the relationships that define the topology of the model being deployed. At 1116, deployment engine 230 can determine a set of processes to be executed to provision the service elements and relationships of the model in the derived order. The operations of 1114 and 1116 may be performed in any appropriate order or concurrently as relationships and service elements are being examined.

Once an order of execution and element-level processes are derived, or determined from a previously specified model-level process, then at 1118, a first process can be selected from a set of processes to provision a first service element according to the order of execution. At 1120, if it is determined that any deployment policies are violated by the first process and/or first service element, then an error message may be sent at 1122. In at least one embodiment, the error message may be provided to a user via a graphical user interface on a display screen of a user system. In other embodiments, the error message may be provided using any other suitable communication technique. If the policy violation is not corrected as determined at 1124, then additional error messages may be sent at 1122. If the selected process and service element do not violate any policies, as determined at 1120, then the process can be initiated to provision the first service element at 1126. If more service elements or relationships still need to be provisioned, as determined at 1128, then flow 1100 may loop back to 1118 to select the next process in the order of execution to provision the next service element and/or relationship. Once all of the service elements and relationships of the model have been provisioned, as determined at 1128, flow 1100 may end.

A composite model with at least one sub-model may be provisioned in a target according to a variation of flow 1100 of FIG. 11. In the variation of flow 1100, a composite model definition may be received at 1102. One or more activities previously described with reference to 1104, 1106, 1108, and 1110 for a single model may also occur with respect to the composite model. At 1112, a determination may be made as to whether a model-level process is associated with the composite model. A model-level process of the composite model may be configured to orchestrate model-level processes of the one or more sub-models (if any sub-models have model-level processes), element-level processes of service elements of the composite model (if any service elements are composed directly in the composite model), element-level processes of service elements composed in any sub-model of the composite model, or any combination thereof. In this case, flow can pass to 1118 to begin the selection of processes from the set of processes orchestrated by the model-level process of the composite model. A process may be selected at 1118 from the set of processes to provision a sub-model, a service element, or a relationship. Thus, the remaining operations in flow 1100 could provision the service elements of the composite model, including service elements of sub-models in the composite model.

If it is determined at 1112 that the composite model is not associated with a model-level process, however, then flow may pass to 1114. At 1114, deployment engine 230 can heuristically derive the order in which to provision the one or more sub-models, service elements of the composite model (if any), and relationships of the composite model. This order of execution can be derived by traversing (or evaluating) at least the relationships that define the topology of the composite model being deployed. At 1116, deployment engine 230 can determine a set of processes to be executed to provision the sub-models, the service elements of the composite model (if any), and relationships of the composite model in the derived order. The operations of 1114 and 1116 may be performed in any appropriate order or concurrently as relationships, service elements of sub-models, and service elements of the composite model are being examined.

Once the set of processes is determined, flow can pass to 1118 to begin the selection of processes from the set of processes determined by deployment engine 230. A process may be selected at 1118 from the set of processes to provision a sub-model, a service element, or a relationship. Thus, the remaining operations in flow 1100 could provision the service elements of the composite model, including service elements of sub-models in the composite model.

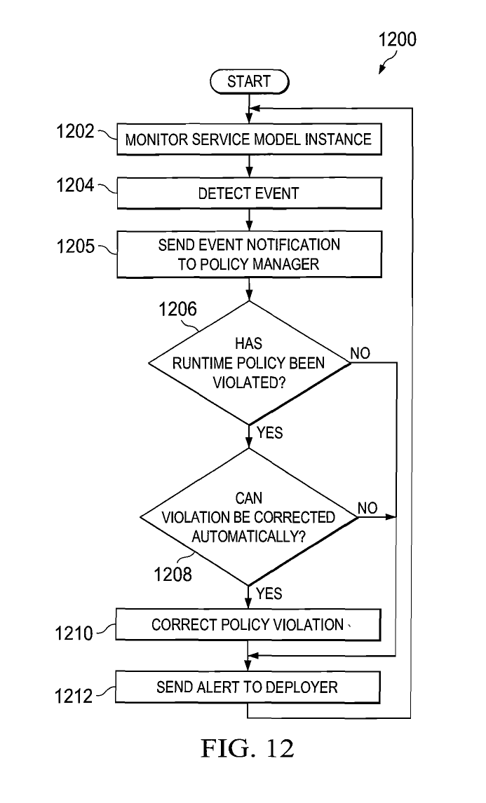

Turning to FIG. 12, a flow chart illustrates activities that may be associated with monitoring a model instance according to an embodiment of intelligent automation system 100. A set of operations may correspond to the activities of FIG. 12. In at least one embodiment, monitoring module 232 and/or policy manager module 235 of server 210(2) may perform at least some of the operations.

A flow 1200 may begin at 1202, where monitoring module 232 monitors a model instance in a target. At 1204 an event may be detected. An example of an event could be the model instance reaching a memory utilization of a certain maximum amount (e.g., 90%). If an event is detected, then an event notification may be sent to a policy manager, such as policy manager module 235. At 1206, a determination is made as to whether a runtime policy has been violated. For example, if a runtime policy has been specified for the model that memory utilization should not exceed a certain maximum amount, then if that specified maximum amount is exceeded, the policy has been violated.

If the determination is made that a runtime policy has been violated, then at 1208, another determination may be made as to whether the violation could be corrected automatically. If the policy violation can be corrected without the intervention of a user, then at 1210, the policy violation may be corrected. In at least one embodiment, the event notification to the policy manager at 1205 may prompt the policy manager to evaluate the policy violation and send appropriate instructions (e.g., to redeployment module 233) to correct the violation, if possible. At 1212, an alert may be sent to a deployer via some suitable communication technique (e.g., displayed message on a graphical user interface in a display screen of a user system, an email, a reporting mechanism, a text message, etc.).

In an example illustration, consider a runtime policy that requires the memory utilization of a model instance to stay below a maximum amount (e.g., 90%) in order to maintain a desired performance level. If memory utilization by the model instance reaches or exceeds the specified maximum amount, then an event indicates current memory utilization of the model instance. In at least one embodiment, monitoring module 232 detects the event and sends a notification to policy manager module 235. Policy manager module 235 may then evaluate whether a runtime policy of the model instance is being violated. If a violation has occurred, then policy manager module 235 may instruct redeployment module 233 to provision another set of memory for the model instance in order to comply with the runtime policy and improve performance. Accordingly, these monitoring and remediation activities facilitate full life cycle creation and management of solutions.

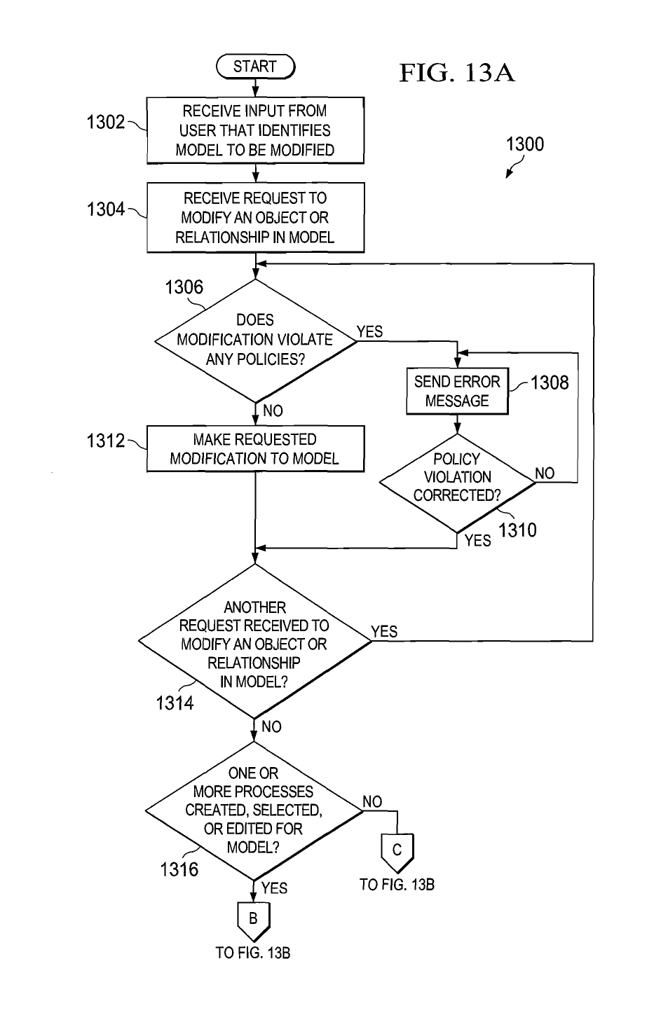

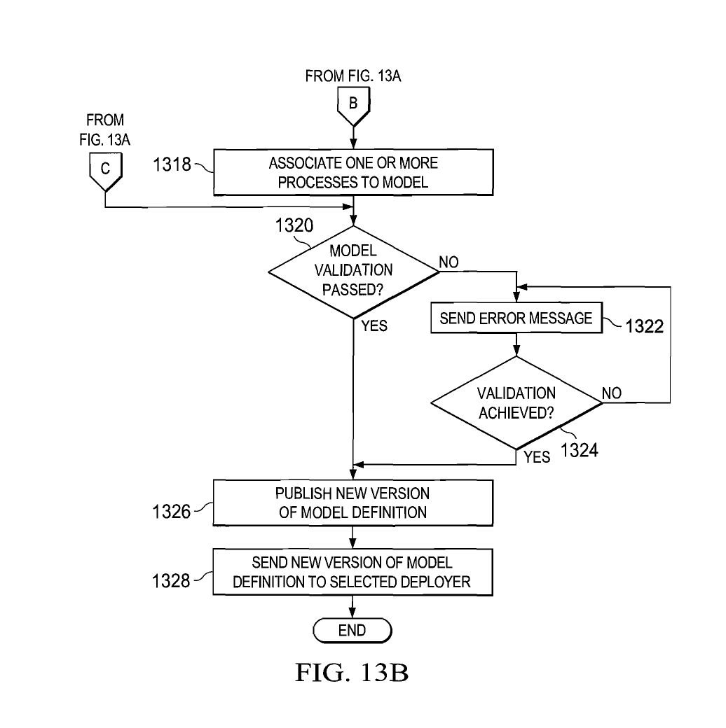

FIGS. 13A and 13B are flow charts illustrating activities that may be associated with modifying a model according to an embodiment of intelligent automation system 100. A set of operations may correspond to the activities of FIGS. 13A and 13B. In at least one embodiment, model editor module 223 of server 210(1) may perform at least some of the operations.

A flow 1300 may begin at 1302, where input is received from a user that identifies a model to be edited. The identifying input could be a unique identifier such as a distinctive name of the model. In an embodiment, identification of the model to be edited may be received from deployment engine 230 when a runtime policy has been violated and cannot be automatically corrected in the deployed domain. At 1304, a request to modify an object and/or relationship in the model may be received. In at least one embodiment, the model may be displayed via a graphical user interface on a display screen of a user system and a request to edit (e.g., delete, replace, modify) a service element, sub-model, or relationship can be made by using appropriate input.

At 1306, a determination is made as to whether the requested modification violates any policies. One or more policies may be specified for objects and/or relationships associated with the requested modification. If the modification violates any of those policies, then an error message may be sent at 1308. In at least one embodiment, the error message may be provided to a user via a graphical user interface on a display screen of a user system. If the policy violation is not corrected as determined at 1310, then additional error messages may be sent at 1308. If the requested modification does not violate any policies, as determined at 1306, then the requested modification can be made at 1312.

At 1314, a determination is made as to whether another request to modify an object or relationship has been received. If so, then flow may return to 1306, to determine whether any policies of the service elements are violated. Accordingly, for each requested modification, a determination is made as to whether the modification to the relationship, sub-model, or service element violates any policies. If no policies are violated, then the modification can be made, but if a policy is violated, then the modification may not be made. In some scenarios, however, a policy may not be violated, but the condition of the policy may be indeterminable (e.g., when a variable is unknown). In this scenario, a policy may trigger an alert message to a user, but may nevertheless allow the modification to be made.

At 1316, a model-level process may be created, selected, or modified for the model. If one or more model-level processes are created, selected, or modified, then these one or more processes may be associated with the model at 1318.

In at least one embodiment, once modifications to the model have been completed, a validation check may be performed on the model. As previously discussed herein, in some instances, a variable may be applied to an object and the value may be based on some other object, or it could be based on targets and deployment configurations. At 1320, a determination is made as to whether a model validation has passed. If the model validation does not pass, then an error message can be sent at 1322. In at least one embodiment, the error message may be provided to a user via a graphical user interface on a display screen of a user system. Model validation may not pass if variables that are based on other objects are not resolved. If validation is not achieved as determined at 1324, then additional error messages may be sent at 1322. Validation may be achieved by resolving the unresolved variables in the model in one example.

If model validation passes at 1320, or if the unresolved variables cannot be resolved until deployment, or if validation is achieved at 1324 after initially failing, then a modified model definition can be published at 1326. In at least one embodiment, publishing the modified model definition includes storing it in models database 214, and indicating it is a newer version than the previous model. The modified model definition describes the desired new state of the solution. The new version of the model definition may be sent to a selected deployer at 1328, in order to redeploy the model based on the new version of the model definition. In at least one embodiment, redeployment module 233 of deployment engine 230 may receive the new version of the model definition and redeploy it in the target, for example, by updating selected components that have been modified or by updating all of the components.

While flow 1300 indicates that objects, relationships, and processes of the model are modified consecutively, this is done for illustrative purposes only. In at least one embodiment, intelligent automation system 1300 is designed to allow flexibility when modifying a model. Accordingly, objects, relationships, and processes may be modified in any appropriate desired sequence.

Note that in certain example implementations, the model-based intelligent automation functions outlined herein may be implemented by logic (e.g., embedded logic provided in an application specific integrated circuit (ASIC), digital signal processor (DSP) instructions, software (potentially inclusive of object code and source code) to be executed by a processor, or other similar machine, etc.). The logic can be encoded in one or more tangible computer-readable media, which can include non-transitory media. In some of these instances, a memory element (as shown in FIG. 2) can store data used for the operations described herein. This includes the memory element being able to store software, logic, code, or processor instructions that are executed to carry out the activities described herein. A processor can execute any type of instructions associated with the data to achieve the operations detailed herein. In one example, the processor (as shown in FIG. 2) could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read only memory (EPROM), an electrically erasable programmable ROM (EEPROM)) or an ASIC that includes digital logic, software, code, electronic instructions, or any suitable combination thereof.

In one example implementation, servers 210(1) and 210(2) may include software in order to achieve the intelligent automation functions outlined herein. These activities can be facilitated by modules of design engine 220 and or modules of deployment engine 230. These modules can be suitably combined in any appropriate manner, which may be based on particular configuration and/or provisioning needs. Servers 210(1) and 210(2) can include memory elements for storing information to be used in achieving the intelligent automation activities, as discussed herein. Additionally, server 110 may include a processor that can execute software or an algorithm to perform the intelligent operations, as disclosed herein. These devices may further keep information in any suitable memory element (random access memory (RAM), ROM, EPROM, EEPROM, ASIC, etc.), software, firmware, hardware, or in any other suitable component, device, element, or object where appropriate and based on particular needs. Any of the memory items discussed herein (e.g., database, tables, cache, etc.) should be construed as being encompassed within the broad term ‘memory element.’ Similarly, any of the potential processing elements, modules, and machines described in this Specification should be construed as being encompassed within the broad term ‘processor.’ Each of the network elements can also include suitable interfaces for receiving, transmitting, and/or otherwise communicating data or information in a network environment.

Note that with the examples provided above, as well as numerous other examples provided herein, interaction may be described in terms of two, three, or four network elements. However, this has been done for purposes of clarity and example only. In certain cases, it may be easier to describe one or more of the functionalities of a given set of flows by only referencing a limited number of network elements. It should be appreciated that intelligent automation system 100 (and its teachings) are readily scalable and can accommodate a large number of components, as well as more complicated/sophisticated arrangements and configurations. In addition, network elements of intelligent automation system 100 could also be consolidated in any suitable arrangement. For example, design engine 220 and deployment engine 230 could be implemented on a single machine. Accordingly, the examples provided should not limit the scope or inhibit the broad teachings of intelligent automation system 100 as potentially applied to a myriad of other architectures.

It is also important to note that the steps in the preceding flow diagrams illustrate only some of the possible scenarios and patterns that may be executed by, or within, intelligent automation system 100. Some of these operations may be deleted or removed where appropriate, or these operations may be modified or changed considerably without departing from the scope of the present disclosure. In addition, a number of these operations have been described as being executed concurrently with, or in parallel to, one or more additional operations. However, the timing of these operations may be altered considerably. Furthermore, a number of these operations have been described as being executed by a particular module, engine, device, or other element. However, these operations may be combined or separated, based on particular needs and implementations, into any suitable modules, engines, devices or other elements. The preceding operational flows have been offered for purposes of example and discussion. Substantial flexibility is provided by intelligent automation system 100 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. For example, screen shots 400, 600, 800, and 1000 are presented in FIGS. 4, 6, 8, and 10, respectively, merely as instances of representations of functions of design engine 220. Various other formats, schemes, styles, interfaces, etc. may be used to configure and manage components of intelligent automation system 100 within the broad teachings of the present disclosure. Also, although screen shots 400, 600, 800, and 1000 are illustrative of graphical user interfaces (GUIs) that allow the user to configure and manage components in the GUIs, any mode of implementation may be used within the broad teachings of this disclosure. For example, a wizard (e.g., a user interface that presents a user with a sequence of dialog boxes that lead the user through a series of well-defined steps) or a command line interface (CLI) allowing the user to create components through commands, may be used in some implementations. Additionally, although intelligent automation system 100 has been illustrated with reference to particular elements and operations that facilitate the communication process, these elements and operations may be replaced by any suitable architecture or process that achieves the intended functionality of intelligent automation system 100.

What is claimed is:

1. A method, comprising:
adding two or more objects to a model;
receiving a request to establish a relationship between first and second objects of the two or more objects;
determining whether the relationship violates a design policy; and
taking an action based on whether the relationship violates the design policy.

2. The method of claim 1, wherein at least one of the objects is a sub-model.

3. The method of claim 1, wherein at least one of the objects is a service element.

4. The method of claim 3, further comprising:
creating the service element based on input from a user;
applying one or more attributes to the service element; and
associating a policy to the service element.

5. The method of claim 1, further comprising:
creating at least one of the two or more objects based on input from a user; and
associating a policy to the at least one object, wherein the policy is one of the design policy, a deployment policy, or a runtime policy.

6. The method of claim 1, wherein the first object includes a first startup process to configure the first object in a target, and wherein the second object includes a second startup process to configure the second object in the target.

7. The method of claim 1, wherein the adding the two or more objects is based on input received from a user, wherein the input includes a drag-and-drop command.

8. The method of claim 1, further comprising:
sending an error message to a display screen of a user system when the requested relationship violates a policy of at least one of the first and second objects.

9. The method of claim 1, further comprising:
establishing the requested relationship between the first and second objects if the requested relationship does not violate any design policy of the first or second objects.

10. The method of claim 1, further comprising:
creating a model-level process for the model, wherein the model-level process includes one or more instructions indicating a sequential order in which to provision the two or more objects.

11. The method of claim 1, further comprising associating a policy to the model.

12. The method of claim 1, further comprising:
selecting a process from a set of processes for execution in a determined order, wherein successful execution of the set of processes in the determined order provisions the two or more objects to establish a model instance in a target;
determining whether the selected process violates a deployment policy; and
taking an action based on whether the selected process violates the deployment policy.

13. The method of claim 12, further comprising:
prior to the process being selected, determining the order in which to provision two or more objects in the target; and
determining the set of processes to be executed in the determined order.

14. The method of claim 13, wherein the determining the order is based, at least in part, on evaluating one or more relationships established between one or more pairs of the objects in the model.

15. The method of claim 12, wherein a model-level process is associated with the model, the model-level process initiating the processes from the set of processes to provision the two or more objects of the model to establish a model instance in the target.

16. The method of claim 12, further comprising:
establishing the model instance in the target by executing the processes in the set of processes in the determined order when no deployment policy is violated by any one of the processes of the set of processes.

17. The method of claim 16, further comprising:
monitoring the model instance in the target based on one or more runtime policies associated with the model; and
taking an action if the model instance violates one of the runtime policies.

18. The method of claim 17, wherein the action comprises:
determining whether the policy violation by the model instance can be corrected automatically; and
correcting the policy violation when the policy violation can be corrected without modifying the model.

19. The method of claim 18, wherein the correcting the policy violation includes re-provisioning the model without modifying the model.

20. At least one non-transitory computer readable medium having instructions stored therein, and when executed the instructions are capable of causing the processor to:
add two or more objects to a model;
receive a request to establish a relationship between first and second objects of the two or more objects;
determine whether the relationship violates a design policy; and
take an action based on whether the relationship violates the design policy.

21. The at least one computer readable medium of claim 20, wherein at least one of the objects is a sub-model.

22. The at least one computer readable medium of claim 20, wherein at least one of the objects is a service element.

23. The at least one computer readable medium of claim 20, wherein when executed, the instructions are capable of further causing the processor to:
prevent the request to establish the relationship from being fulfilled when the requested relationship violates a policy of at least one of the first and second objects.

24. The at least one computer readable medium of claim 20, wherein when executed, the instructions are capable of further causing the processor to:
establish the requested relationship between the first and second objects if the requested relationship does not violate any design policy of the first or second objects.

25. The at least one computer readable medium of claim 20, wherein when executed, the instructions are capable of further causing the processor to:
select a process from a set of processes for execution in a determined order, wherein successful execution of the set of processes in the determined order provisions the two or more objects to establish a model instance in a target;
determine whether the selected process violates a deployment policy; and
take an action based on whether the selected process violates the deployment policy.

26. The at least one computer readable medium of claim 25, wherein when executed, the instructions are capable of further causing the processor to:
prior to the process being selected, determine the order in which to provision the two or more objects in the target; and
determine the set of processes to be executed in the determined order, wherein the order is determined based, at least in part, on evaluating one or more relationships established between one or more pairs of the objects in the model.

27. An apparatus, comprising:
at least one memory element configured to store data;
a design engine associated with instructions; and
at least one processor operable to execute instructions associated with the design engine to:
add two or more objects to a model;
receive a request to establish a relationship between first and second objects of the two or more objects;
determine whether the relationship violates a design policy; and
take an action based on whether the relationship violates the design policy.

28. The apparatus of claim 27, wherein at least one of the objects is a service element, wherein the at least one processor is operable to execute further instructions associated with the design engine to:
prior to the addition of the two or more objects to the model, create at least one of the two or more objects of the model, based on input from a user;
apply one or more attributes to the service element; and
associate the design policy to the service element.

29. The apparatus of claim 27, wherein the relationship is selected from a group of relationships comprising: uses, inherits from, hosts, is deployed in, and invokes.

30. The apparatus of claim 27, wherein the each of the two or more objects includes one or more element-level processes, at least some of the one or more element-level processes to be executed in a predetermined order to provision the model as a model instance in a target.

31. The apparatus of claim 27, wherein the design policy defines a requirement for a certain type of content of at least one of the first and second objects, wherein the relationship is determined to violate the design policy when the requirement is not met.
